(19) United States
(12) Patent Application Publication
(10) Pub. No.: US 2018/0096402 A1
(43) Pub. Date: Apr. 5, 2018

(54) METHOD AND SYSTEM FOR NETWORKING AND FUND RAISING TO BENEFIT CHARITIES

(71) Applicant: SQWIRREL LLC, BLOOMFIELD HILLS, MI (US)

(72) Inventor: VARCHASVI SHANKAR, WEST BLOOMFIELD, MI (US)

(21) Appl. No.: 15/724,537

(22) Filed: Oct. 4, 2017

Related U.S. Application Data
(60) Provisional application No. 62/404,333, filed on Oct. 5, 2016.

(51) Int. Cl. G06Q 30/02; G06Q 10/06; H04L 12/18; G06F 3/0482; H04L 29/08; G06Q 50/00

(52) U.S. Cl. CPC G06Q 30/0279; G06Q 10/06311; H04L 12/1818; G06Q 50/01; G06F 3/0482; H04L 67/306; G06Q 30/0232

(57) ABSTRACT

A system/web/mobile application is provided for facilitating meetings between users registered with the system. The system may provide a profile with biographical and other information for each of the users. The system may provide for corporate, charity, and advertiser users who all may promote their respective brands, goods, and/or services. The system provides for making connections between users for sharing information and/or mentoring between users and may facilitate events and bridges, or meetings between users, particularly between executives and general users in exchange for a required charitable donation paid by the general user. The users may be associated with charities and the collected required charitable donations may go to a charity of their choice. The system provides charity and/or corporation accounts the ability to host events to provide monetary and non-monetary benefits to charities and to monitor the success of fundraisers and charity drives.

### CROSS REFERENCE TO RELATED APPLICATIONS

This Utility patent application claims the benefit of U.S. Provisional Patent Application Ser. No. 62/404,333 filed Oct. 5, 2016 entitled “Computer-Based Method and System for Networking and Fund Raising to Benefit Charities” which is hereby incorporated by reference in its entirety.

### BACKGROUND OF THE DISCLOSURE

### 1. Field of the Invention

The present invention relates generally to computer-based systems and methods for networking while correspondingly benefiting charities.

### 2. Related Art

Systems and methods are known in the art for providing networking between individuals or organizations. Many such systems are computer-based and provide users with accounts that they can use to share information and to connect with other users. Such systems, like LinkedIn and Meetup.com, are generally known as “social media” and include functionality aimed to facilitate networking between individuals.

These social networking systems also may have different categories of users, such as users who are individuals, and users that are corporations or advertisers, which may all have different functionality within the system. It is also known to use a server having a computer readable storage medium for storing data related to a plurality of different accounts, and for the server to communicate with one or more user devices via one or more communications networks such as, for example, via the internet and via wireless data networks.

However, there exists a need for a social media system and method that allows individuals to promote and network themselves, and possibly their related companies within social media via means which simultaneously benefit charities.

### SUMMARY OF THE INVENTION

The present invention relates to a system and method for networking and fund raising to benefit charities. Specifically, the system includes a server having a non-transitory computer readable medium storing data related to a plurality of different accounts for generating a user interface specific to each of the different accounts.

The system may include a first account associated with and including biographical information regarding a first user and a second account associated with and including biographical information regarding a second user. The system includes a user interface that is specific to either the first account or the second account, which includes a bridge control for requesting a private meeting with another user of the system. A user interface that is specific to either the first account or the second account includes a bridge fee indicator presenting a required charitable donation for the user associated with that account to participate in a private meeting with another user. Such a private meeting between users is characterized as a “bridge.”

In some cases, one or more of the users may be executives who meet certain criteria of the system. Users who are not executives may be designated as general users. Private meetings may present a number of benefits for each user involved. For example, general users may receive access to executives who are not easily accessible in a normal business environment, opportunities for mentoring, and a chance for individual attention of the executive which may help the general user to gain insight on leadership thought process and to improve knowledge and to share ideas. Executive members also receive their own benefits from participating in private meetings, including access to qualified motivated people (as demonstrated by their desire to pay for a private meeting with that executive member). Additional benefits to the executive member may include supporting a charity and boosting that executive member's social image.

A computer implemented method for networking and fund raising to benefit charities is also provided. The method includes the steps of receiving, by a server, a request from a first user to create a profile. The request from the first user may be communicated to the server via a communications network. The method continues with providing, by a user device or the server, profile input fields for obtaining profile information about the first user. The method also includes receiving by the server, a request from a second user to create a profile. The request from the second user may also be communicated to the server via a communications network. The method proceeds with the step of providing, by a user device or the server, profile input fields for obtaining profile information about the second user. The method includes selecting, by a user, a bridge invitation control to participate in a private meeting with another user who is designated as being available for private meetings. The method concludes with the step of prompting, by a user device or the server, for the user requesting the private meeting to pay a required charitable donation in order to participate in the private meeting.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 illustrates a system for networking and fundraising to benefit charities;

FIG. 2 is a block diagram illustrating elements of the system for networking and fundraising to benefit charities;

FIG. 3 illustrates an exemplary home screen for display on a user interface associated with the system;

FIG. 4 illustrates an exemplary profile view screen for display on the user interface associated with the system;

FIG. 5 illustrates an exemplary connections screen for display on the user interface associated with the system;

FIG. 6A illustrates an exemplary private bridge screen for display on the user interface associated with the system;

FIG. 6B illustrates an exemplary bridging profile configuration control for display on the user interface associated with the system;

FIG. 7 illustrates an exemplary charity screen for display on the user interface associated with the system;

FIG. 8 illustrates an exemplary corporate screen for display on the user interface associated with the system;

FIG. 9 illustrates an exemplary event data screen for display on the user interface associated with the system; and

FIG. 10 is a block diagram illustrating functional elements of an embodiment of a system in accordance with an aspect of the disclosure;

FIG. 11 is a flow chart illustrating method steps for an embodiment of a server according to an aspect of the disclosure;

FIG. 12 is a flow chart illustrating additional method steps;

FIG. 13 is a flow chart illustrating additional method steps;

FIG. 14 is a flow chart illustrating additional method steps; and

FIG. 15 is a flow chart illustrating additional method steps.

### DESCRIPTION OF THE ENABLING EMBODIMENTS

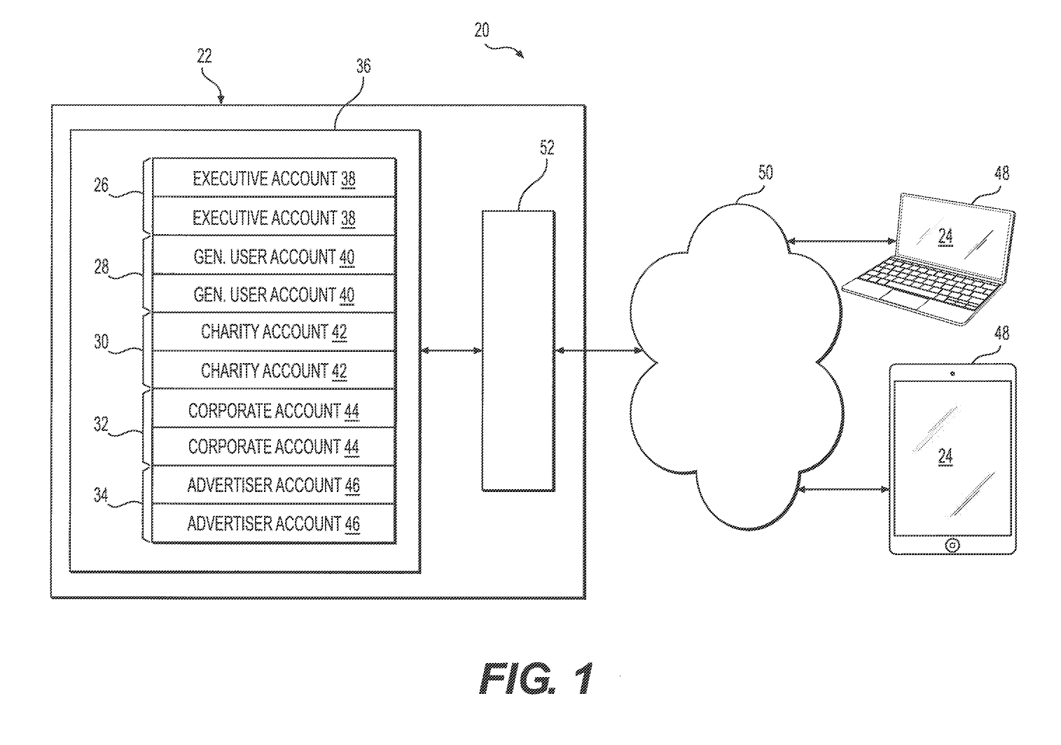

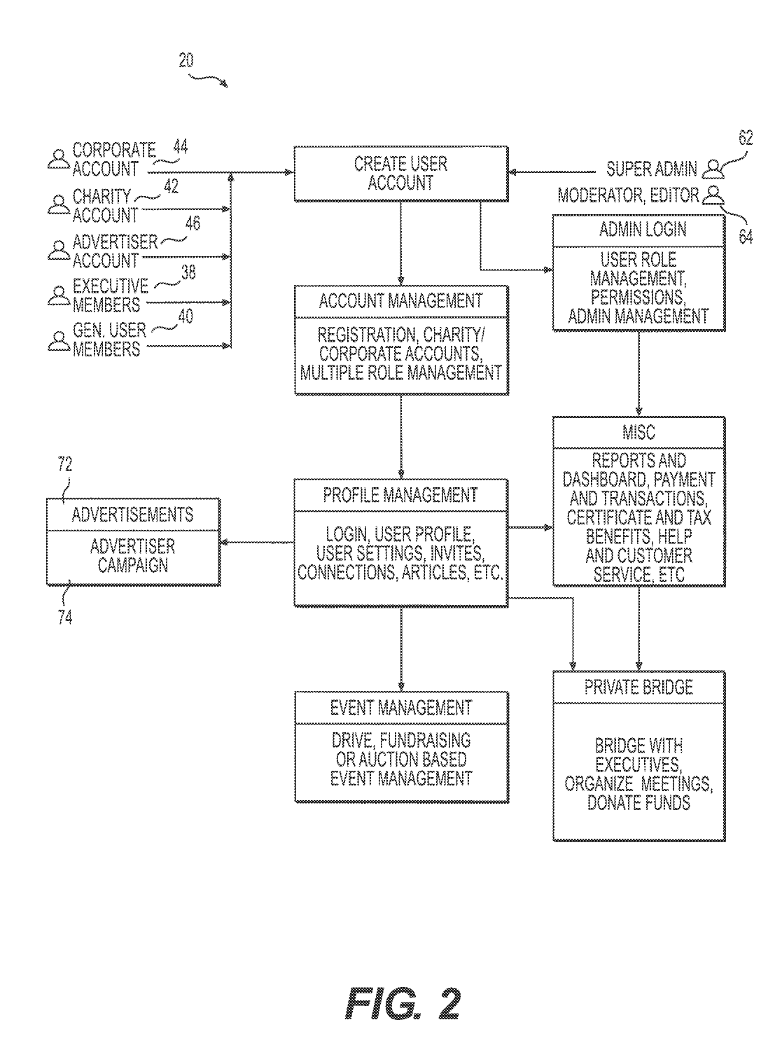

Referring to the Figures, wherein like numerals indicate corresponding parts throughout the several views, a system 20 for networking and fund raising to benefit charitable causes is generally shown in FIGS. 1-2.

As best shown in FIG. 1, the system 20 includes a server 22 for generating a user interface 24 specific to each of a plurality of different user categories 26, 28, 30, 32, 34 and having a non-transitory computer readable storage medium 36 for storing data related to a plurality of different accounts 38, 40, 42, 44, 46. As shown in FIG. 1, there may be multiple different accounts 38, 40, 42, 44, 46 in each of the user categories 26, 28, 30, 32, 34. Each of the user categories 26, 28, 30, 32, 34 may have any number of different accounts 38, 40, 42, 44, 46. The system 20 could even have zero accounts associated with one or more of the user categories 26, 28, 30, 32, 34, such as, for instance, if Executives were not provided with their own, separate, first category 26 of users. In practice, the server 22 may include one or more physical or virtualized computer processors 52 and may include volatile or nonvolatile data storage, including the non-transitory computer readable storage medium 36 as one or more electrical, magnetic, or optical memories including but not limited to: RAM, cache, hard drive, Flash, CD-ROM drive, tape drive or removable storage disk.

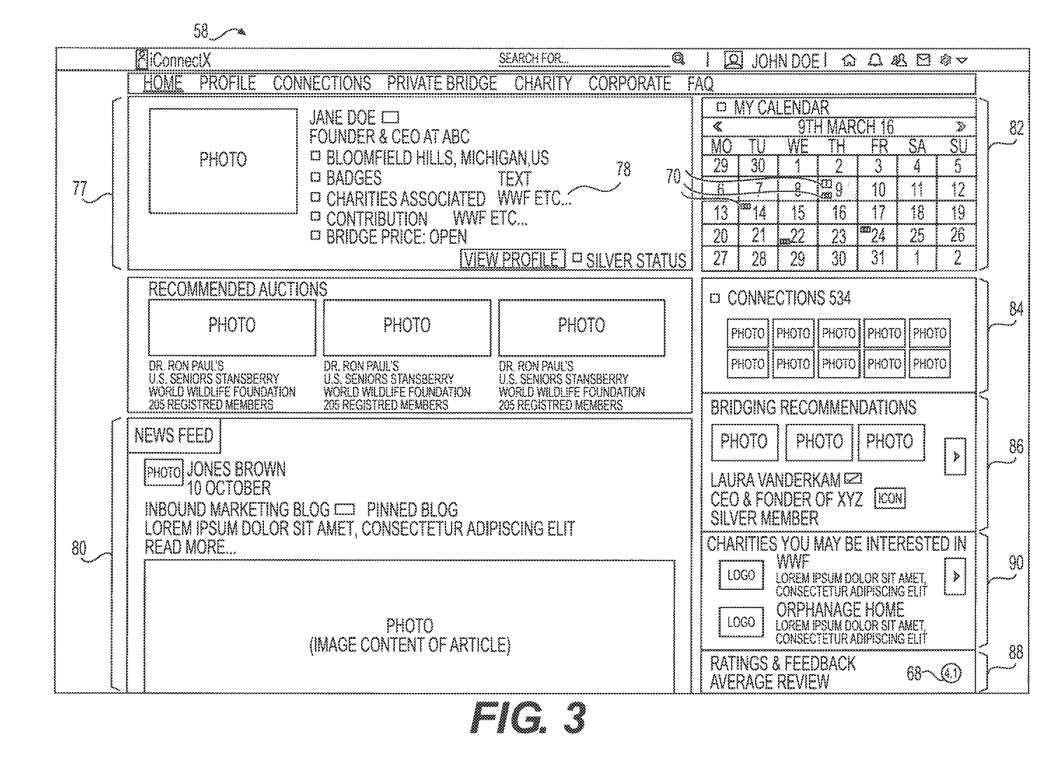

As best shown in FIG. 1, the server 22 communicates with a plurality of different user devices 48 via a communications network 50, such as the internet, a local area network (LAN), or a wireless data network, to provide the user interface 24. The communications network 50 may also include two or more networks such as, for example, the internet and a mobile wireless data network. As will be discussed in more detail below, and as best illustrated in FIGS. 3-9, the user interface 24 may include several different screens 58, 60, 61, 63, 71, 92, 102 which are dynamically generated and tailored to include information and controls related to each of several different user categories 26, 28, 30, 32, 34 of users. The user interfaces 24 may be generated by the processor 52 of the server 22. The user interfaces 24 or portions thereof may also be generated by a user device 48 using data provided by the server 22. The user interfaces 24 may take one of several different forms such as, for example, a web page, a mobile or PC-based application (app) or program, a kiosk interface, or any other suitable means of user interaction with the system 20.

As best illustrated in FIGS. 3-9, the user device 48 provides the user with information and may also solicit input data from the user, including, for example, by providing the input fields and prompts for the user to enter biographical information regarding himself or herself. The user device 48 may be a device used directly by the user such as, for example, a personal computer such as a traditional desktop or laptop computer, a smartphone, tablet, kiosk, or other such device that a user may interact with. Alternately, the user device 48 may be separated from the user, such as, for example, a virtual machine running on a mainframe or other centralized computer. Furthermore, the server 22 may provide the user interfaces 24 through which the user interacts, for example, by dynamically generating images of displays and/or controls. The user device 48 may also comprise a combination of two or more different devices working in combination, such as, for example, a terminal used by the operator providing a user interface 24 that is generated by a separate computer and sent, for example, over a computer network or the internet, and which may include wired and/or wireless portions.

As best illustrated in FIGS. 1-2, the plurality of different user categories 26, 28, 30, 32, 34 includes a first category 26 of users having an executive account 38 on the system 20. A first user may be an executive at a corporation or other private or public organization, and correspondingly associated with this first category 26 of users. According to an aspect, members of the first category 26 can also include prominent members of their respective community, such as but not limited to former executives, politicians, authors, celebrities, academics, or commentators. Members of the first category 26 of users may be solicited by invitation from administrators and/or editors 64 of the system 20. New members of the first category 26 may also be solicited by referral from other, existing executive users.

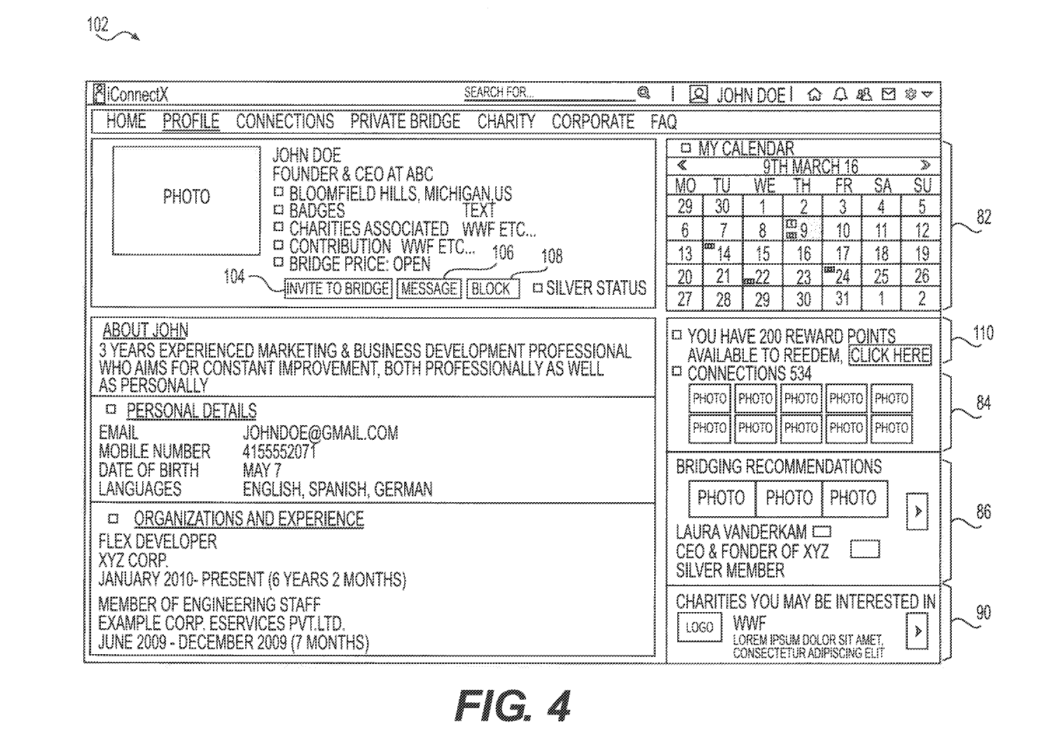

As illustrated in FIGS. 3-4, in the process of creating a user account, the system 20 may prompt the executive first user individual to provide information regarding himself or herself. Such information may include biographical information such as, but not limited to: name, address, birth date, email, employer, job title, and personal and professional affiliations. The birth date (or birth year) may be used to verify that users are at least a given age, such as 18 years old, and therefore able to legally participate and/or to make payments such as with a credit card. The information provided may include one or more pictures. The information to be provided may also include subjects or activities of particular interest to the individual. According to an aspect, the system 20 may provide a plurality of possible activities, which may be presented as a grid or list from which the individual may select.

Verification of executive status may be required by a moderator or editor 64 of the system 20 before an executive account 38 on the system 20 is active, publicly accessible, and/or is able to participate in designated activities such as meetings or events. As will be described in more detail below, the executive account 38 also includes a list of charities 78 for which the first user desires to benefit from private meetings, or bridges, setup via the system 20.

As best illustrated in FIGS. 1 and 2, according to another aspect, the plurality of different user categories 26, 28, 30, 32, 34 also includes a second category 28 of users having a general user account 40 on the system 20. A second user, who may be a general member of the public, is associated with the second category 28 of users. This general user account 40 is the default account type that is available without any special qualifications. However, according to an aspect, a general user account 40 may only be available to persons who have been invited or persons who are employees or are otherwise affiliated with one or more specified organizations. Similar to the executive account 38, the general user account 40 also includes biographical information regarding the second user, and may include pictures, professional and personal affiliations, a rating associated with the second individual, and a listing or summary of the bridges and events that the second individual has attended. Users belonging to the first category 26 and the second category 28 may collectively be called iConnectX members.

According to a further aspect, the plurality of different user categories 26, 28, 30, 32, 34 also includes a third category 30 of charities having a charity account 42 on the system 20. Several different charity organizations may be associated with the third category 30 of charities. A charity may qualify as a member of the third category 30 by one or more known methods of certifying organizations as charities, such as: tax status, a 503(c) organization, recognition by a given third-party certifier or accreditor of charities, or by approval by one or more moderators, editors 64, or administrators of the system 20. As will be explained in more detail below, charity accounts 42 allow individual charities to promote themselves, to organize and promote events, and to raise funds.

According to a further aspect, the plurality of different user categories 26, 28, 30, 32, 34 also includes a fourth category 32 of corporations having a corporate account 44 on the system 20. Several different corporate organizations may be associated with the fourth category 32 of corporations. Members of the fourth category 32 may include corporations or other non-charity organizations who seek to promote themselves while benefiting one or more charities. As will be explained in more detail below, corporate accounts 44 allow corporate organizations to promote themselves and to organize and promote events.

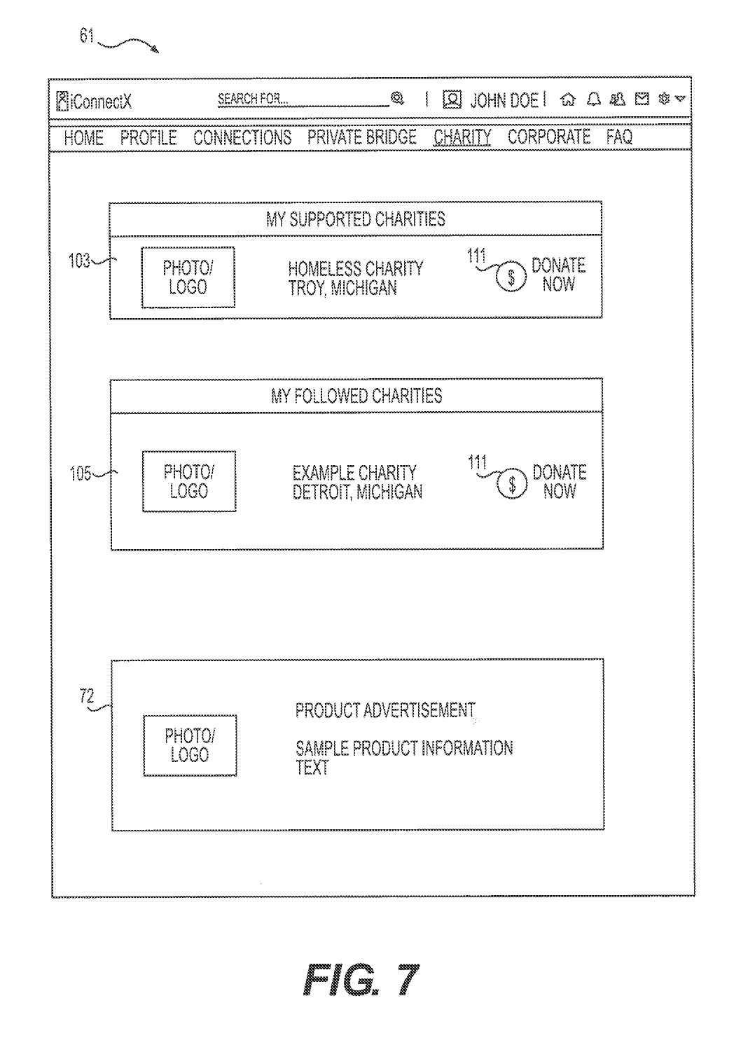

According to a further aspect, the plurality of different user categories 26, 28, 30, 32, 34 also includes a fifth category 34 of advertisers having an advertiser account 46 on the system 20. Several different advertiser organizations may be associated with the fifth category 34 of advertisers. An advertiser account 46 may purchase space to post advertisements 72 for their goods or services on the user interfaces 24 of the system 20. Advertisements 72 may be presented to specific users based on keyword or other matching characteristics and may be part of a larger advertiser campaign 74. An example advertisement 72 is shown on FIG. 7.

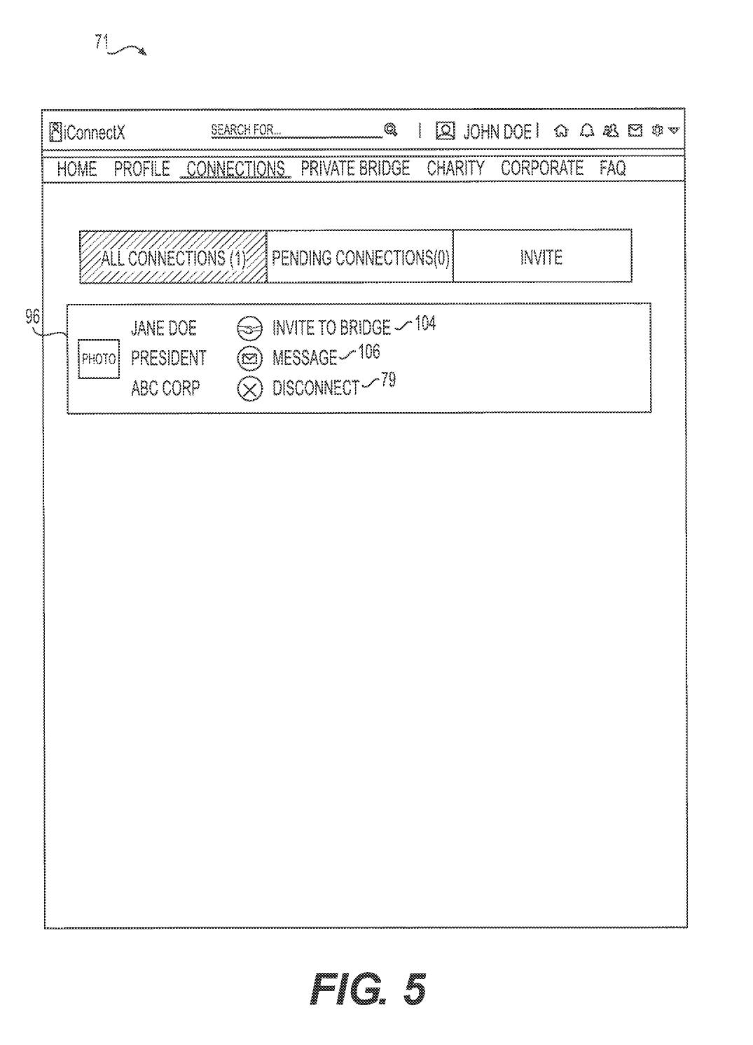

As best shown in FIG. 5, the system 20 includes a connections screen 71 from which individual users of the system 20, such as the first user or the second user, may request to connect with other users of the system 20. A user who has been requested to connect may be notified and may be asked by the system 20 to confirm or to deny the request to connect. If the request to connect is confirmed, the two users are each designated as being connections with one another. Once users have become connections with one another, the system 20 may list the connected user with a connection control 96 on the connections screen 71. As shown on FIG. 5, the connection controls 96 may include summary biographical information such as a name, title, and picture of the connection, as well as controls for functions associated with that connection. The system 20 may provide for one or more communications paths between users who are connections with one-another, which may include, for example, direct messaging between one another and/or communication paths which are unavailable to non-connected users such as access to portions of the other user's profile data which are designated as being shared only with connections. The connection control 96 may include may include, for example, a message control 106 for sending a message to the other user via the system 20. The controls may also include a “disconnect” button 79 for causing the other user to cease to be a connection. Users may also be able to post or to submit information to the system 20 which may be displayed on the home screen 58 of other users who are connections with the posting user.

In particular, and as illustrated on FIGS. 4, 5, and 6A, individual users of the system 20 may request to “bridge” (i.e. to participate in a private meeting) with one more other users by using a bridge invitation control 104. Bridges may be arranged as “face to face” or in-person meetings, or phone or electronic connections such as audio, text, or video conference. A private meeting may be one of several different types including in-person, conference call, etc., and may include a specific purpose such as, for example, a sales pitch or presentation by the individual user requesting the private meeting.

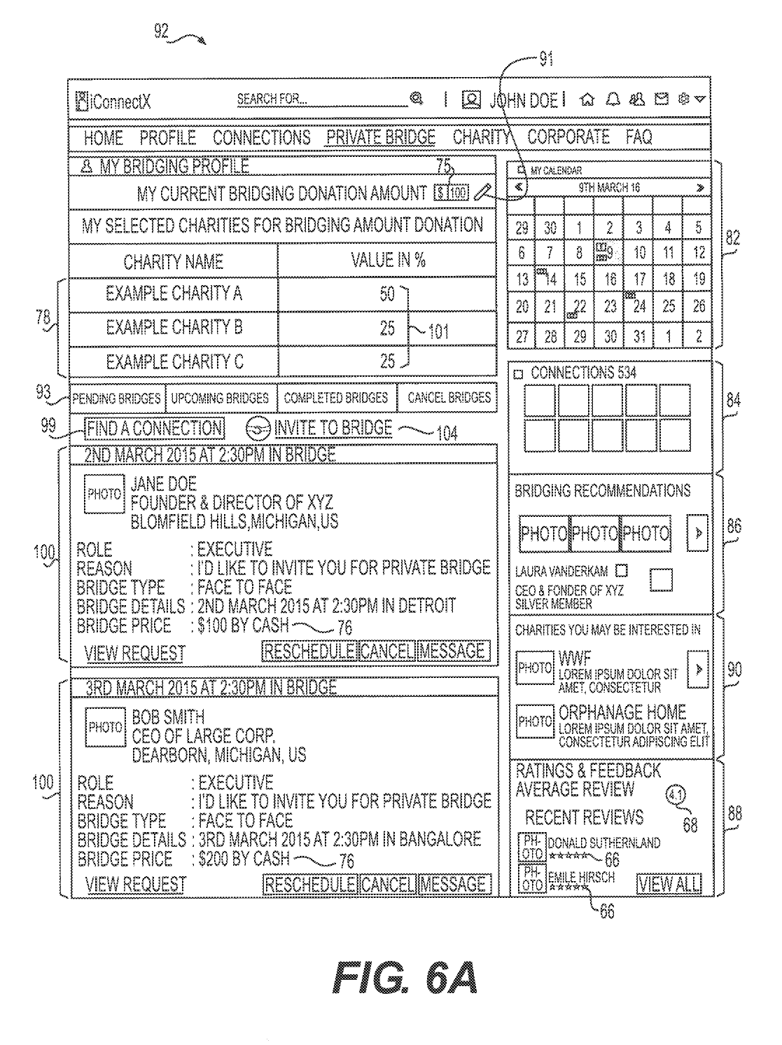

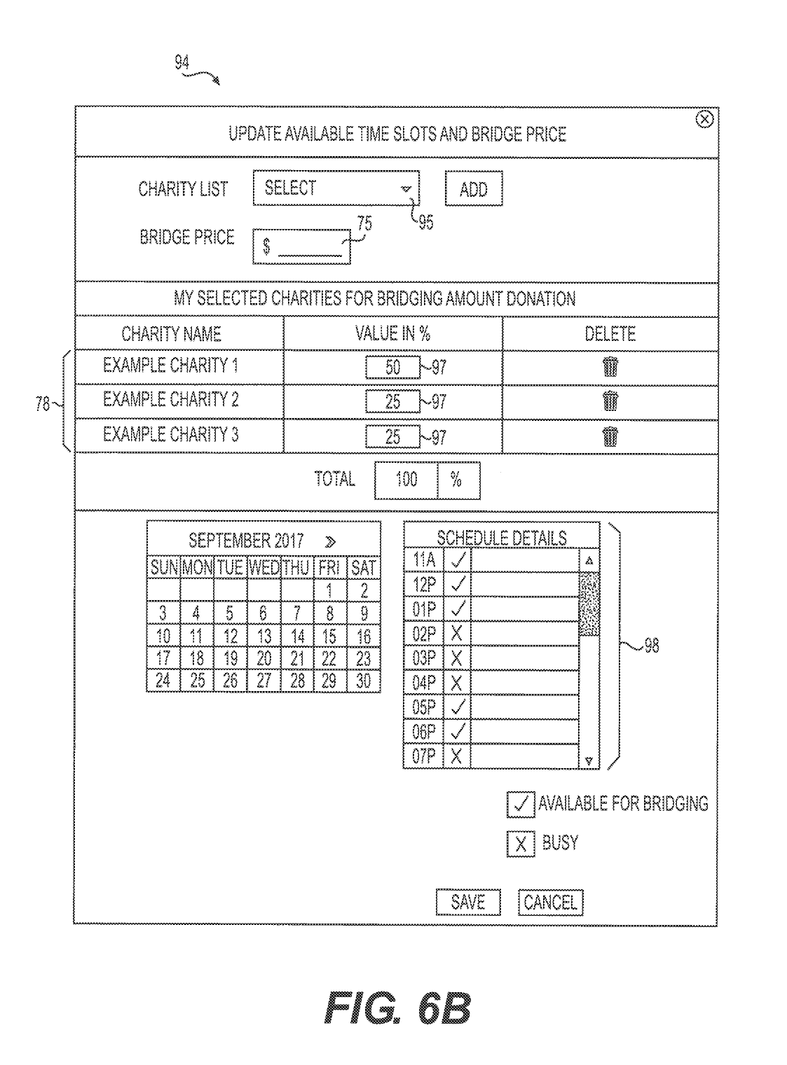

As best shown in FIG. 6A, users must pay a required charitable donation in order to participate in a bridge with a member of the first category 26 of executive users. Such payments may be processed directly by the system 20 or by another party, such as, for instance, by a third party gateway for credit cards. In requesting to bridge, the recipient may be provided with profile information regarding the requesting user along with details of the proposed meeting. Such details may include one or more proposed dates and times for meeting, along with a preferred meeting type (in-person, phone conference, video conference, etc.). Such details may also include subject matter to be discussed at the proposed meeting. Following the meeting, the required charitable donation is distributed to one or more charities, which may be selected by one of the users in the private meeting. The requestee user may select the beneficiary charities and the allocation percentages for how the charitable donation is distributed. The one or more charities to whom the required charitable donation is distributed may be restricted to those charities having a charity account 42 with the system 20. Alternatively, the required charitable donation, or a portion thereof, may be distributed to a charity that does not have a charity account 42 with the system 20. A portion of the required charitable donation may be withheld by the system 20 as an administrative fee.

Bridges may present a number of benefits for each user including opportunities for mentoring, access to executives who are not easily accessible to members of the general public, and who would not otherwise be motivated to give their time for such private meetings, but who would be motivated to do so by the charitable benefits provided by the required charitable donation. The private meeting (“bridge”) also provides individuals with the advantage of one-on-one attention which may focus on the individual, and which may help the user to gain insight on leadership thought process and to improve knowledge and to share ideas. Additional benefits include supporting their favorite charity and boosting the user's social image. Users may set and track their personal goals for charity funding. Users may choose whether or not to make their personal goals and/or funding progress public.

A first rating control (not shown) may be provided for the first user to enter or to set the rating 66 associated with the second user. A second rating control (not shown) may be provided for the second user to enter or to set the rating 66 associated with the first user. Each of the rating controls may be provided to the associated user automatically and a short time after the private meeting is scheduled to be complete. The ratings 66 may be, for example, from one to five stars, with one star being the most negative rating available and five stars being the most positive rating available. The system may record the ratings 66 provided to calculate an overall rating score 68 for that user.

As shown in FIG. 2, the system 20 may have a super admin user 62, which may otherwise be called an administrator, with full access and control of the system 20. Moderator and/or editor 64 accounts may be provided with limited access and control of the system 20. Moderators or editors 64 may, for example, have access and duties to perform managerial services on the system 20 including but not limited to approving or verifying new users or events, and removing content posted by users and which is designated as offensive or otherwise prohibited.

As best illustrated in FIG. 3, the system 20 includes a home screen 58, which may be called a “Home” interface, and which presents indicators and controls specific to each of the user categories 26, 28, 30, 32, 34. As shown in FIG. 3, the home screen 58 for the first category 26 of users who are executives may include a summary of that user's profile information 77 such as their name, title, and picture. It may also include a list of charities 78 that the user is associated with and a summary or listing of recent charitable contributions made by the user, ratings & feedback 88 that the user has received in reviews from other users in the past, as well as a recommended charities listing 90 of charities that the user may be interested in following and/or supporting and which may be selected by the system 20 based on one or more factors, which may include, for example, interests selected by that user, past use, charities supported by other users having similar interests or by users who are connections to that user. The user's home screen 58 may include a list of activities or auctions related to charitable causes and directed to that particular user and a news feed 80 listing of news stories or articles that are provided to that user based on several factors and sources including but not limited to the user's history of use of the system 20, preferences, connections with other users, and sponsored content from advertisers. A calendar 82 is provided on the user's home screen 58 that includes icons 70 with information regarding meetings and/or events that the user has scheduled. A connections listing 84 of other users with whom the user has connected may also be provided. Bridging recommendations 86 may also be shown on the user's home screen 58 with a listing of users available for a bridge or private meeting.

According to another aspect, and as shown on FIG. 4, a public profile 102 may be available to show profile data that each user has entered into the system 20. Each user may have control over what particular profile is shared with each type of other users. For example, an executive user may choose to share his name, title, city, and picture with all other users, and his email address and bridge status with connected users, and his phone number or address with only the administrator of the system 20. A user's public profile 102 includes a bridge invitation control 104 for initiating a request to schedule a bridge with that user. A user's public profile 102 also includes a message control 106 for sending a message to that user and a block control 108 for preventing communications from that user.

As best shown in FIG. 6A, the system 20 includes a private bridge screen 92 to allow the first and second users to setup a bridge as previously discussed. The private bridge screen 92 may include a fee setting 75 for the amount of a required charitable donation that other users would be charged for participating in the private meeting. The fee setting 75 may also function as an availability setting. In other words, a user who has no monetary value set with the fee setting 75 may be unavailable for bridges. The fee setting 75 may be initially provided with no monetary set, and a user would only become available for bridges after setting a monetary value of their choosing in the fee setting 75. An availability setting may also be implemented in other ways such as, for instance, as an available/unavailable button. A list of charities 78 is provided to show the beneficiaries of the required charitable donation. An allocation percentage 101 may also be provided to show percentage of the required charitable donation that each of the listed charities will receive. Bridge navigation controls 93 may be provided to provide views of pending bridges, upcoming bridges, completed bridges, and to cancel pending bridges. An edit button 91 may be included to provide access to a bridging profile control 94 (FIG. 6B), which includes settings related to bridges, and which is described in more detail below. Bridge summaries 100 may be provided to show items related to pending, upcoming, and/or completed bridges. The bridge summaries 100 may each include a bridge fee indicator 76 showing the amount of the required charitable donation associated with that bridge. A connection search box 99 may be provided for a user to enter the name of a connection who may then be directly invited to participate in a private meeting using a bridge invitation control 104, which may take the form of a button or a hyperlink type text. A calendar 82 may be provided on the user's private bridge screen 92 that includes icons 70 with information regarding meetings and/or events that the user has scheduled.

As shown in FIG. 6B, the bridging profile control 94 may include several different settings related to bridges. The bridging profile control 94 may take the form of a whole screen, part of a screen, or otherwise, such as, for instance, as a pop-up window. A charity list selector 95 may be provided to allow the user to select from several different charities to be added to the list of charities 78 as beneficiaries of the required charitable donation to participate in a bridge. The charities selected using the charity list selector 95 may then be listed in the list of charities 78, which may also include corresponding allocation controls 97 for the user to adjust the allocation percentages 101 of the required charitable donation that would go to each of those charities. A fee setting 75 may also be provided for adjusting the amount of the required charitable donation that other users would be charged for participating in the private meeting. The bridging profile control 94 may further include a schedule setting 98 for the user to designate one or more dates and times that the associated user is available for a private meeting, and which may include weekly or monthly availability time slots. The schedule setting 98 may also provide for the user to designate one or more times as being unavailable, or “busy”.

According to one aspect, only members of the first category 26 of users who are executives are able to solicit bridges, including setting the required charitable donation and designating one or more charities as a recipient of the required charitable donation. Alternatively, either members of the first category 26 of users who are executives or members of the second category 28 who are general users are able to solicit bridges. According to an aspect, any user may be able to setup their profile to accept bridges with other users. According to a further aspect, a corporate organization or a charity may solicit bridges for meeting with a person designated by that organization, who may be, for example, an executive with that organization or a person otherwise affiliated with that organization, such as a spokesperson or a celebrity endorser.

According to an aspect, and as shown on FIG. 4, reward points 110 may be awarded to the users by the system 20 on the basis of participation in bridges. According to a further aspect, the number of reward points 110 that are awarded to a user may be determined based upon the rating that user received from other users who participated in a bridge with the user. According to an aspect, the number of reward points 110 that are awarded may be determined based on the amount of the required charitable donation that is paid by the user for participation in the bridge. The reward points 110 may be redeemable for a good or service which may be provided by a sponsor. A user may have an option to receive the goods or services in exchange for accumulated reward points 110 or to donate the prize or a monetary equivalent to their supported charity. Reward points 110 may also be awarded to users for participation in or for charitable donations made in events managed in the system 20, such as, for example fundraisers or drives, which are described in more detail below.

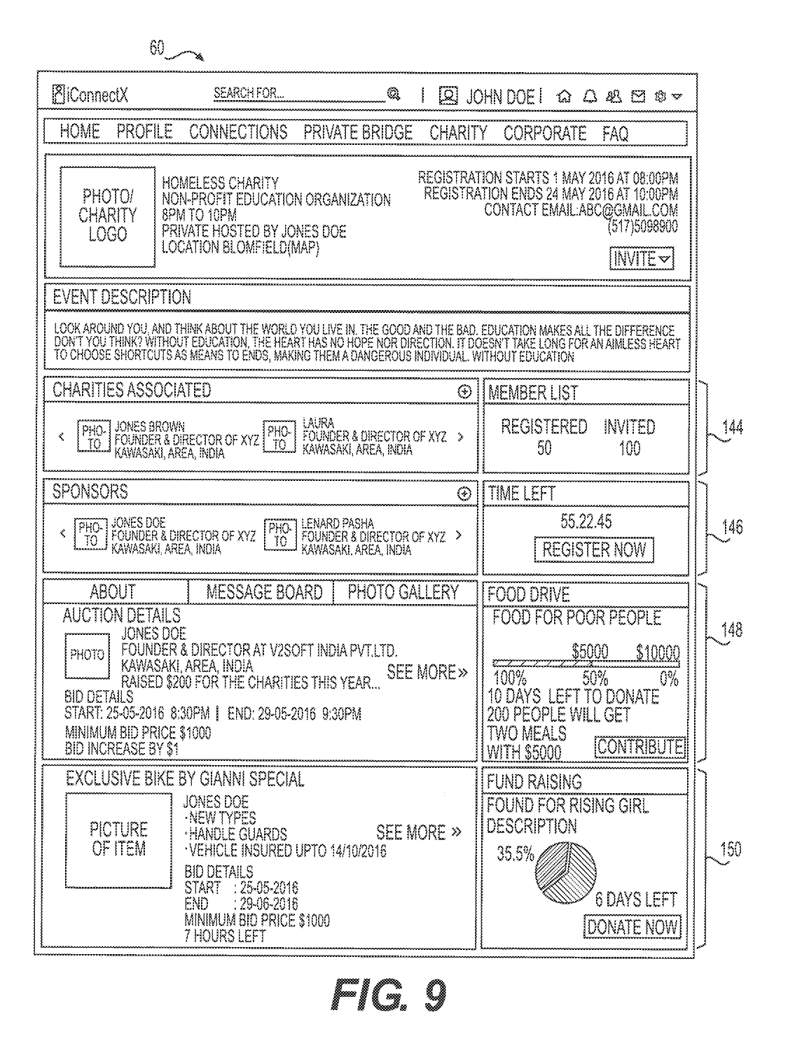

According to an aspect, and as illustrated on FIG. 9, a user of the system 20 may create an event on the system 20. The user may then be designated as a host of the event. Events may be entirely confined to an online presence through the system 20 or they may include a real-world component such as a dinner, a meeting or any other function. Events may also be arranged as an organized bridge with a list of executive users, sponsors, and charity organizations associated therewith.

The system 20 may provide an event configuration interface screen which is available to the host for setting event options, which may include but are not limited to: the event being public or private; other users who are invited to the event; one or more charities associated with the event; one or more sponsors associated with the event; whether the event is ticketed or non-ticketed; whether it is a monetary event or a non-monetary event; layout of the event data screen 60; graphics and other information related to the event. The system 20 may provide an event data screen 60 with information regarding the event and which is available to the public or is accessible only to invitees and which may include comments from the invitees.

A monetary event may be a fundraising event for soliciting monetary donations in support of one or more charities associated with the fundraising event. According to an aspect and as shown in FIG. 3, a monetary event may include an auction for soliciting bids on bridge meetings or other goods or services in support of one or more charities associated with the fundraising event. Such an auction may include a bidding period of time during which bids are collected for each of the goods and/or services available for bid. According to an aspect, the auction may be conducted as one of a public auction in which all bids are visible. Alternatively, the auction may be conducted as a silent auction in which a bidder cannot see bids associated with other bidders and where the bidder is only notified in response to having placed the highest bid at the end of the bidding period. A non-monetary event may be, for example, a drive such as a collection of food or toys for the needy. A non-monetary event may also have the goal of raising awareness of a particular charity or cause. An event may have both monetary and non-monetary components.

As best illustrated in FIG. 7, the system 20 includes a charity screen 61 presenting information regarding one or more charities having charity accounts 42. The charity screen 61 may include information regarding the associated charity, and which may include for example its purpose and goals, contact information, events and executive users that are associated with that charity. The charity screen 61 may include one or more charities as supported charities 103 that the user has committed to support. The charity screen 61 may include one or more charities as followed charities 105, which may be selected by the user, and which may provide status updates to the user such as, by posting information to that user's home screen 58. The charity screen 61 may also include bibliographic information regarding persons associated with the charity, including, for example, its founder, board members, and/or major contributors. The charity screen 61 may further include status updates from the charity having the charity account 42. The charity screen 61 may include controls such as a “donate now” button 111 to enable a user to support the charity having the charity account 42 with monetary or non-monetary donations, and/or to contact the charity having the charity account 42.

An example of an advertisement 72 is also included on the charity screen 61, which includes text as well as a photo or logo provided by the advertiser. Advertisements 72 may take other forms such as, for instance, being entirely textual, and/or being integrally placed within other content, such as within the user's news feed 80 on the user's home screen 58.

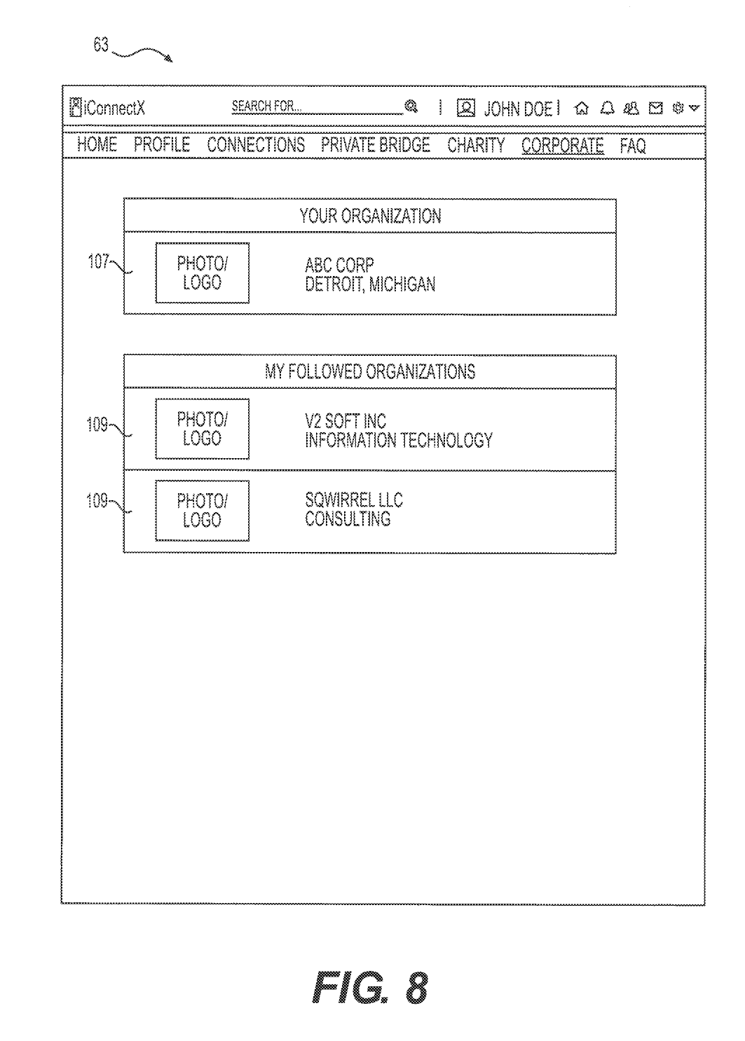

As best illustrated in FIG. 8, the system 20 includes a corporate screen 63 presenting information regarding one or more corporations having a corporate account 44. As shown in FIG. 8, the corporate screen 63 may include a user-associated organization 107 that the user has identified as being associated with. The corporate screen 63 may also include one or more followed organizations 109 which may be selected by the user, and which may provide status updates to the user such as, by posting information to that user's home screen 58. Each of the user-associated organization 107 and the followed organizations 109 may be represented with a logo or image. The name of the organization and/or other information regarding the organization, such as an industry or location, may also be provided. The corporate screen 63 may include a control to follow specific corporate accounts 44. It may include a control to invite a corporate account 44 to participate in or to sponsor an event. According to an aspect, the corporate screen 63 may include events and/or drives associated with one or more corporate accounts 44 and which may be held to benefit one or more charities. The corporate screen 63 may include background information about a corporation associated with a corporate account 44 and may include contact information, job postings, a list of associated executives, and/or charities that the associated corporation supports. According to an aspect, the corporate screen 63 may include status or news information posted to the system 20 by one or more corporate accounts 44.

According to an aspect, any of the user profile screen, the charity profile screen, or the corporate screen 63 may include a control to enable a user to follow the user or organization having the account associated with that profile screen, which is designated as a followed account. A followed account may operate similar to making a connection with another user. A followed account may, for example, allow status updates from the followed account to show up in the user's news feed 80 on the user's home screen 58. A user's home screen 58 may indicate what other accounts that user is following. The system 20 may include controls for a user to manage the accounts which that user follows, and which may, for example, allow for additional accounts to be followed or for currently followed accounts to be un-followed.

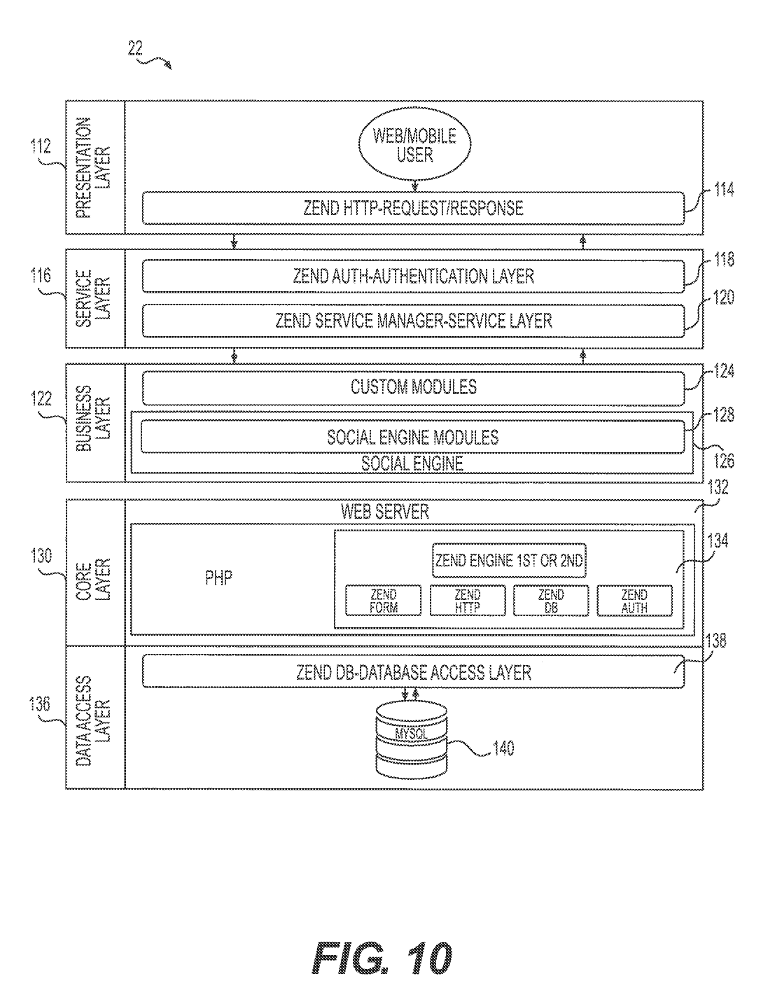

According to another aspect of the invention and as best shown in FIG. 10, the system 20 for networking and fund raising to benefit charitable causes may include computer-executable instructions stored in a non-transitory computer readable storage medium 36 of the server 22. The computer-executable instructions may include a presentation layer 112 for generating and serving dynamic user interfaces 24 to a plurality of different users via a network, and which may use the Zend HTTP component 114 to provide secure request and response. The presentation layer 112 may communicate directly and bi-directionally with a service layer 116 that includes an authentication layer 118 which may use Zend Auth. and a service manager 120 which may use Zend Service Manager 120. Together, the authentication layer 118 and service manager 120 will serve to secure the application from malicious attacks and to provide data to the business layer 122. The service layer 116 may communicate directly and bi-directionally with a business layer 122 which may include custom modules 124 and/or a social network engine 126 having a plurality of social engine modules 128.

The system 20 may also comprise a core layer 130 including a web server 132 which may be implemented in PHP and interpreted by a Zend Engine 134; and a data access layer 136 which may include a database access layer 138 running Zend DB with a MySQL database 140. The Database 140 may use an encryption protocol such as AES256 for encryption and decryption of sensitive data. The application may be developed on a model-view-controller (MCV) architecture so the presentation layer 112 cannot directly access the data access layer 136 and must interact through the business layer 122.

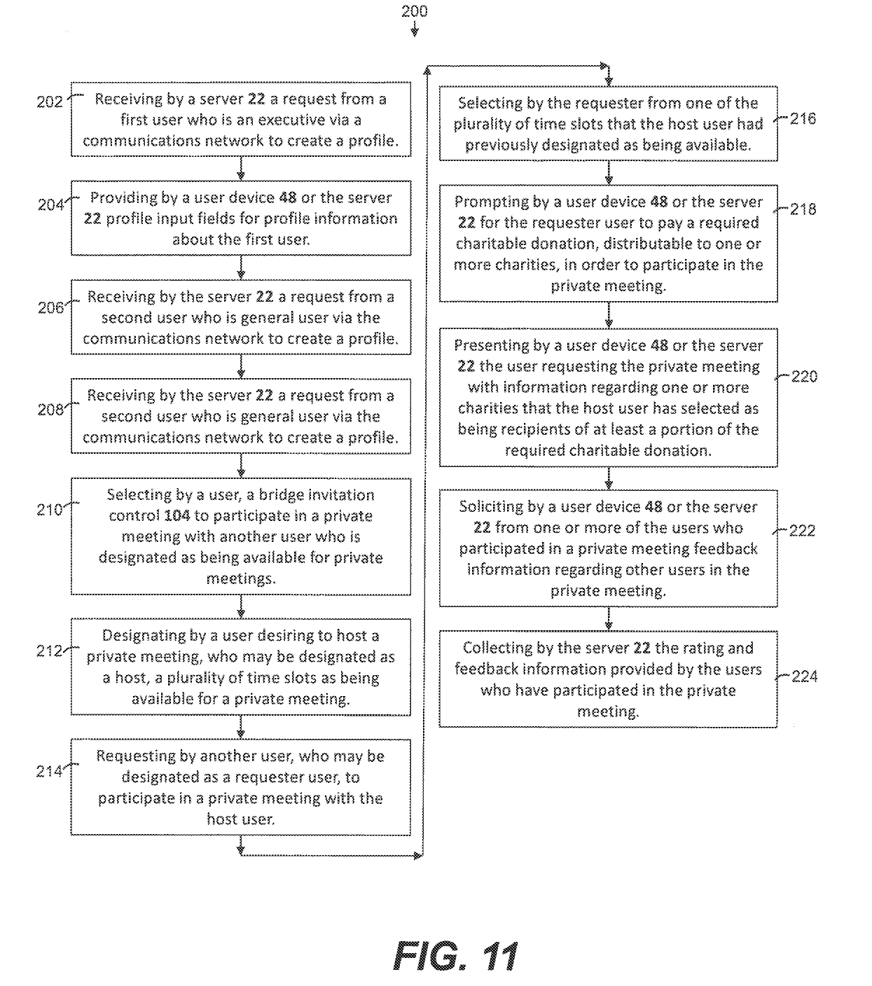

As generally shown in FIGS. 11-15, the subject disclosure is also related to a computer implemented method 200 for networking and fund raising to benefit charities. The method 200 begins at step 202 by receiving at a server 22 a request from a first user, such as an executive, via a communications network 50 to create a profile. A profile associated with an executive may be associated by the system 20 with an executive account 38 and may include biographical information about that first user. The second user may also be a general user who is not necessarily an executive. Such biographical information may be as simple as a name, but may include several other items such as, for example, a title and a business associated with the first user. Biographical information may include one or more photos and may also include contact information such as one or more phone numbers, email addresses, and/or physical addresses.

Executive accounts 38 may provide several benefits to the first user. For example, the system 20 may provide exposure to the first user and his or her business. The system 20 may also provide for networking opportunities and several different means to benefit charities. The benefits provided by the first user to charities may be promoted publicly by the system 20 which may provide the first user with positive exposure.

The method 200 also includes 204 providing by a user device 48 or the server 22 profile input fields for profile information about the first user, which may include availability to meet with other users. The profile input fields may also include places for the first user to designate one or more charities to be associated with that user. Profile input fields may allow the first user, or executive user, with the ability to control what information about themselves is available to other users, to users who are connected with the first user and/or what is available publicly.

The method 200 also includes 206 receiving by the server 22 a request from a second user, who is designated a general user, via the communications network 50 to create a profile. The method 200 may also include the step of 208 providing by a user device 48 or the server 22 profile input fields for profile information about the second user. The profile input fields may also include places for the second user to designate one or more charities to be associated with that user.

According to an aspect, the method 200 may include 210 selecting by a user, a bridge invitation control 104 to participate in a private meeting, which may also be called a “bridge,” with another user who is designated as being available for private meetings. Such private meetings may involve two or more users and may take place in person, or otherwise such as, for example, via phone or video conference.

The method 200 may include the step of 212 designating, by a user desiring to host a private meeting, a plurality of one or more time slots when that user is available for a private meeting. The user hosting a private meeting or desiring to do so may be designated as a “host”. According to an aspect, only executives may be able to host private meetings. In other words, the system 20 may provide executive users with the ability to designate themselves as being available for private meetings.

The method 200 may include 214 requesting by another user, who may be designated as a requester user, to participate in a private meeting, i.e. “bridge,” with the host user. The method 200 may also include 216 selecting by the requester from one of the plurality of time slots that the host user had previously designated as being available.

The method 200 may include 218 prompting by a user device 48 or the server 22 for the requester user to pay a required charitable donation, distributable to one or more charities, in order to participate in the private meeting. The system 20 may distribute the required charitable donation upon the occurrence of the private meeting. The system 20 may distribute the required charitable donation at the scheduled time of the private meeting, provided that the private meeting was not canceled before that time. Alternatively, the system 20 may distribute the required charitable donation upon one or more of the users having confirmed the occurrence of the private meeting. The amount of the required charitable donation may be publicly displayed for the user desiring to host a private meeting. The required charitable donation may be designated by the host as benefiting one or more charities. Such a designation of the charities supported may also be publicly displayed such as, for example, on the profile of the user desiring to host a public meeting.

The method 200 may also include 220 presenting by a user device 48 or the server 22 the user requesting the private meeting with information regarding one or more charities that the host user has selected as being recipients of at least a portion of the required charitable donation. The method 200 may include 222 soliciting by a user device 48 or the server 22 from one or more of the users who have participated in a private meeting a rating and/or feedback information such as comments regarding the bridge and the other user or users in the private meeting. Guidelines may be provided regarding rating the other user based upon the effectiveness, worth, or other aspects of the meeting. Negative or low ratings or scores may be associated with a user who fails to show up for a scheduled meeting.

The method 200 may further include 224 collecting by the server 22 the rating and feedback information provided by the users who have participated in the private meeting. The server 22 may record or store the collected rating 66 and feedback information. The server 22 may process the rating and/or feedback information and may, for example, generate an overall rating score 68 of a particular user, which may be, for example, based on the average of the ratings that user has received. The system 20 may take remedial action against a user having ratings and/or feedback that is negative and/or an overall rating score 68 which is below a threshold value. For example, a user who receives a given percentage of ratings 66 below a threshold value may have their account revoked.

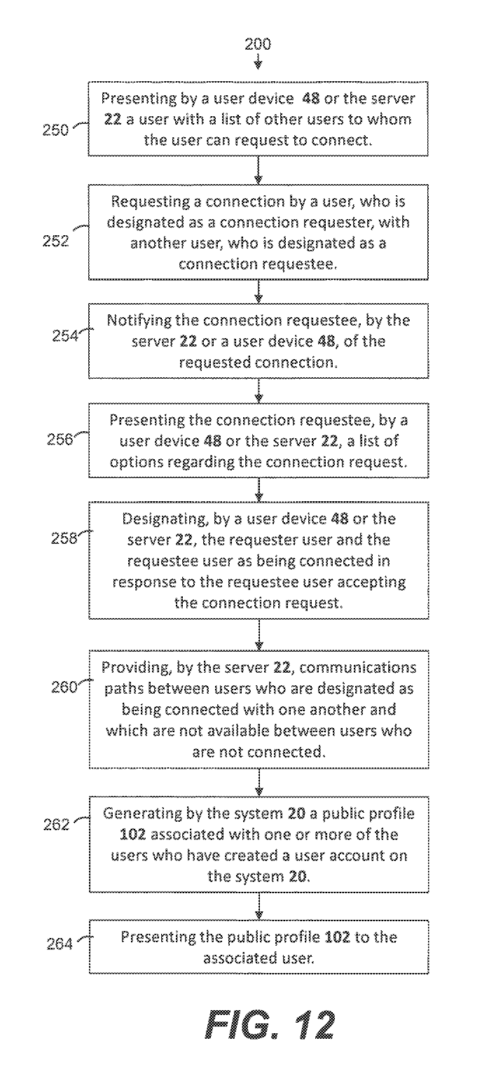

As shown in the flow chart of FIG. 12, the method 200 may further include one or more of the steps of: 250 presenting by a user device 48 or the server 22 a user with a list of other users to whom the user can request to connect; and 252 requesting a connection by a user, who is designated as a connection requester, with another user, who is designated as a connection requestee. The method 200 may proceed by 254 notifying the connection requestee, by the server 22 or a user device 48, of the requested connection, which may include information regarding the connection requester. For example, a connection requestee may be presented by the system 20 with a notification of the connection request, along with biographical information regarding the connection requestor, which may enable the connection requestee to decide how to handle the request, such as, for example, whether to accept, reject, or to ignore the connection request.

The method 200 may proceed with the steps of 256 presenting the connection requestee, by a user device 48 or the server 22, a list of options regarding the connection request. The list of options may include, for example, options for accepting the connection and for rejecting the connection. The method 200 may include 258 designating, by a user device 48 or the server 22, the requester user and the requestee user as being connected in response to the requestee user accepting the connection request.

The method 200 may also include 260 providing, by the server 22, one or more communications paths between users who are designated as being connected with one another and which are not available between users who are not connected. Such additional communications paths may include, for example, direct messaging, audio or video connections, text messaging, email messaging, sending or exchange of predetermined messages, and/or an exchange of contact information.

According to an aspect, the method 200 may include the step of 262 generating by the system 20 a public profile 102 associated with one or more of the users who have a user account on the system 20. The method 200 may proceed with the step of 264 presenting the public profile 102 to the associated user. According to an aspect, each user may set the availability of their associated public profile 102 according to one of several privacy settings from being fully public to being shared with no one except for the user.

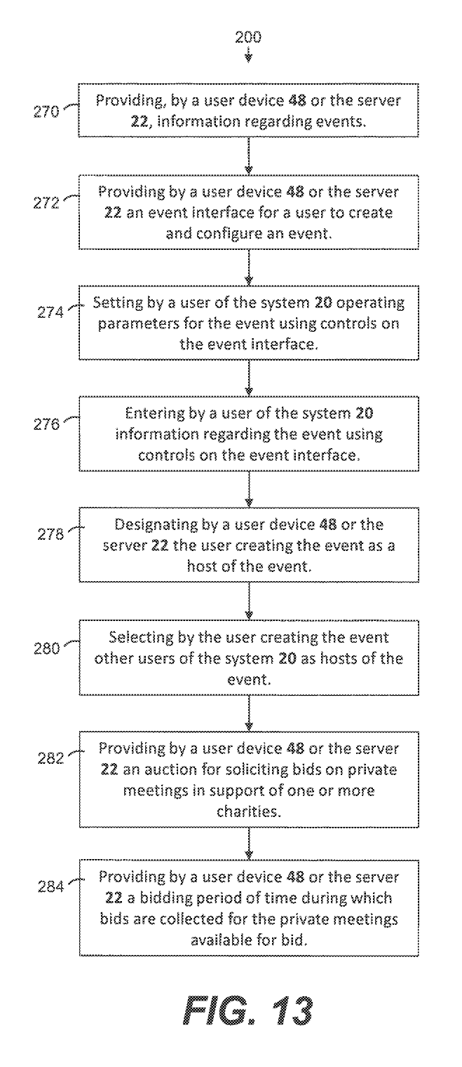

As illustrated in the flow charts of FIG. 13, the method 200 may also include one or more of the steps of 270 providing, by a user device 48 or the server 22, information regarding events. The method 200 may include 272 providing by a user device 48 or the server 22 an event interface for a user to create and configure an event. The method 200 may proceed with 274 setting by a user of the system 20 operating parameters for the event using controls on the event interface. Such operating parameters may include, for example, the type of the event (e.g. fundraiser, drive, etc.), whether the event is in-person or online, the date, time, and duration of the event, etc. The method 200 may include 276 entering by a user of the system 20 information regarding the event using controls on the event interface. The information regarding the event may include, for example, the title and/or beneficiaries of the event. The information regarding the event may also include goals of the event, such as fundraising goals.

The method 200 may include 278 designating by a user device 48 or the server 22 the user creating the event as a host of the event. According to an aspect, the method 200 may include 280 selecting by the user creating the event other users of the system 20 as hosts of the event. There may be, for instance several different users of the system 20 who are designated as hosts of any given event. The method 200 may also include 282 providing by a user device 48 or the server 22 an auction for soliciting bids on private meetings in support of one or more charities. Auctions may also be provided for fundraising for soliciting bids on other goods or services. The method 200 may also include 284 providing by a user device 48 or the server 22 a bidding period of time during which bids are collected for the private meetings available for bid.

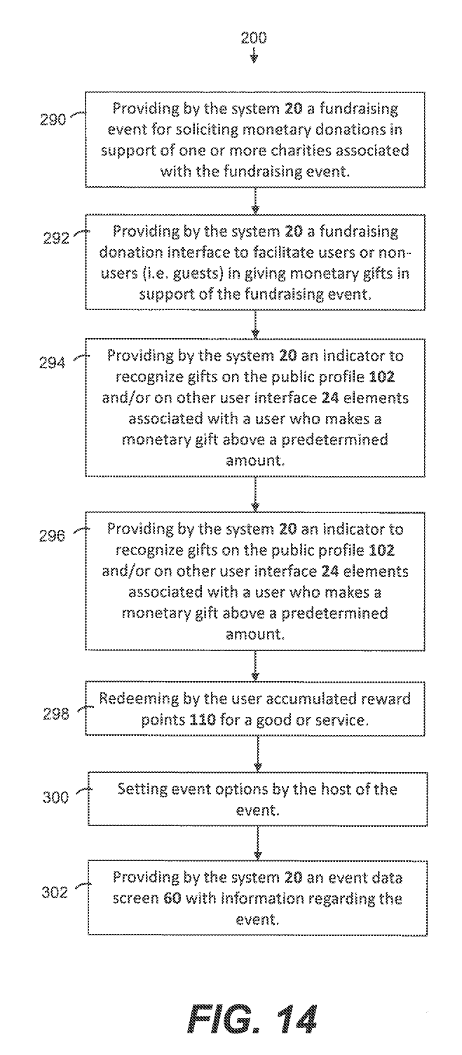

As illustrated in the flow chart of FIG. 14, the method 200 may further include the step of 290 providing by the system 20 a fundraising event for soliciting monetary donations in support of one or more charities associated with the fundraising event. As shown in FIG. 6A, an event data screen 60 may be provided by the system 20 and may include background information regarding the fundraising event such as the specific cause to be supported. The event data screen 60 may include status indicators 144, 146, 148, 150 to display status information related to events. As shown in FIG. 9, a member list 144 may be provided to show the number of members or users who are invited and who are registered for a given event. A registration control 146 may be provided to allow a user to register for an event, and which may also show the time remaining or a deadline for registration. A drive summary graphic 148 may be provided which may include information regarding a drive event, and which may also include, for example, a graphic indicator of progress toward a goal, with details of that goal, time remaining for the drive event, and a button for the user to contribute toward the drive. A fundraiser graphic 150 may also be provided, and which may include information regarding a fundraiser event including a summary of the goal or goals, a graphic indicator of an amount raised toward a goal, time remaining for the event, and a button for the user to contribute toward the fundraising event.

The method 200 may proceed with the step of 292 providing by the system 20 a fundraising donation interface to facilitate users or non-users (i.e. guests) in giving monetary gifts in support of the fundraising event. The method 200 may further include 294 providing by the system 20 an indicator to recognize gifts on the public profile 102 and/or on other user interface 24 elements associated with a user who makes a monetary gift above a predetermined amount. Such indicators may include, for example, badges or icons 70 that recognize the gift. Indicators may be a numeric descriptor of the amount given or a textual indicator which may take the form of a headline such as, for example “congratulations to user X for contributing (amount) to (charity name)!”

The method 200 may also include 296 providing by the system 20 reward points 110 which may be based on monetary gifts given. For example, a user may receive 1 reward point 110 for every $10 given to charities using the system 20. The method 200 may also include the step of 298 redeeming by the user accumulated reward points 110 for a good or service. According to an aspect, the good or service may be provided by a sponsor, and may be a donation.

The method 200 may proceed with the step of 300 setting event options by the host of the event. The system 20 may provide an event configuration interface screen with user adjustable controls for setting the event options. Such event options may include, for example: the event being public or private; other users who are invited to the event; one or more charities associated with the event; one or more sponsors associated with the event; whether the event is ticketed or non-ticketed; whether it is a monetary event or a non-monetary event; layout of the event data screen 60; graphics and other information related to the event.

The method 200 may also include 302 providing by the system 20 an event data screen 60 with information regarding the event. According to an aspect, the event data screen 60 may be is available to the public. Alternatively, the event data screen 60 may be accessible only to invitees of that event. Access to the event data screen 60 may be configured using one of the event options.

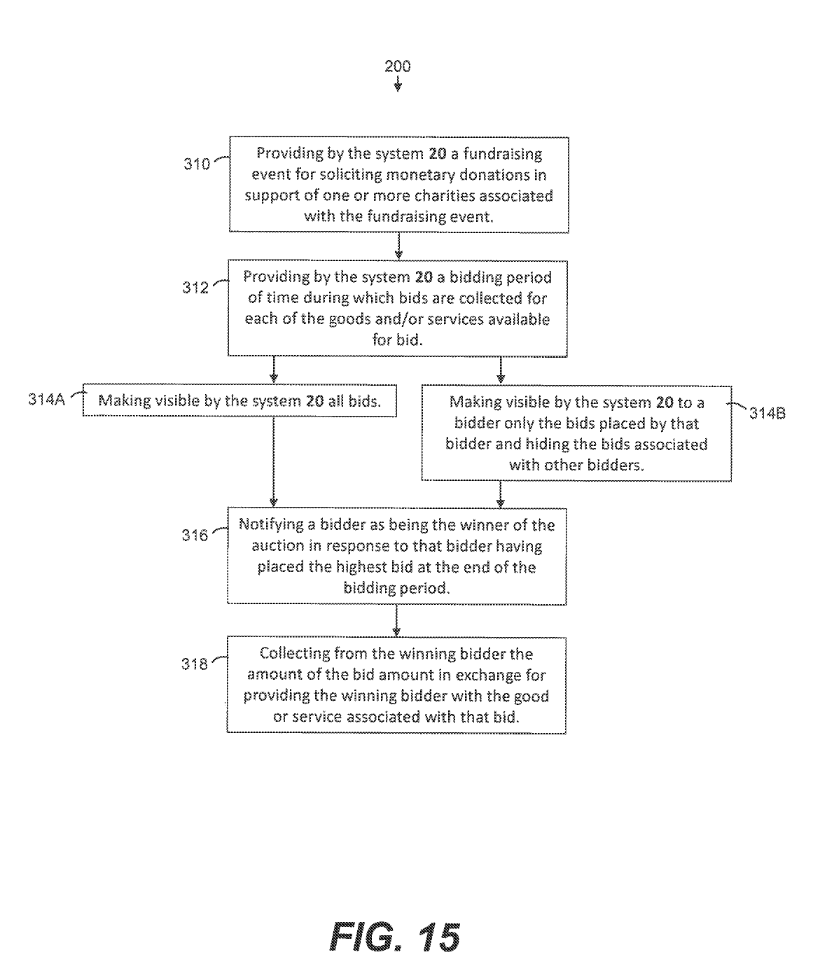

According to another aspect, and as described in the flow chart of FIG. 15, the method 200 may include 310 providing by the system 20 an auction for soliciting bids on bridge meetings or other goods or services in support of one or more charities associated with a fundraising event. The method 200 may proceed with the step of 312 providing by the system 20 a bidding period of time during which bids are collected for each of the goods and/or services available for bid. According to an aspect, the auction may be conducted as a public auction in which the method 200 includes 314A making visible by the system 20 all bids. Alternatively, the auction may be conducted as a silent auction in which the method 200 includes 314B making visible by the system 20 to a bidder only the bids placed by that bidder and hiding the bids associated with other bidders. The method may proceed with the step of 316 notifying a bidder as being the winner of the auction in response to that bidder having placed the highest bid at the end of the bidding period. Notification may be provided automatically by the system 20, and may include sending a message, such as an email, text message, or phone call to the user. The system 20 may provide notification through the user interface 24, such as by providing a message within the system 20 and/or with a notification on one or more of the screens 58, 60, 61, 63, 71, 92, 102.

The method 200 may continue with the step of 318 collecting from the winning bidder the amount of the bid amount in exchange for providing the winning bidder with the good or service associated with that bid. The step of 318 collecting from the winning bidder may be done automatically by the system 20, such as by providing the winning bidder with a payment screen or payment window as part of the user interface 24 and which accepts the payment such as by accepting a credit card or bank account information. Alternatively, the system 20 may use a third party payment processor such as Pay Pal or Google Wallet to receive the payment. The step may also be performed by a person, for example, where the auction is a live event, a cashier may perform the step of 318 collecting payment from the winning bidder.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Obviously, many modifications and variations of the present invention are possible in light of the above teachings and may be practiced otherwise than as specifically described while within the scope of the appended claims.

What is claimed is:

1. A system for networking and fund raising to benefit charities, comprising:
a server having a non-transitory computer readable storage medium storing data related to a plurality of different accounts for generating a user interface specific to each of said different accounts;
said plurality of different accounts including a first account associated with and including biographical information regarding a first user;
said plurality of different accounts including a second account associated with and including biographical information regarding a second user;
one of said user interfaces specific to said first account or said second account including a bridge control for requesting a private meeting with a user of the other of said first account or said second account; and
one of said user interfaces specific to said first account or said second account including a bridge fee indicator presenting a required charitable donation to participate in the requested private meeting.

2. The system for networking and fund raising to benefit charities of claim 1 wherein said user interface specific to said first account or said second account includes a fee setting for adjusting an amount of the required charitable donation.

3. The system for networking and fund raising to benefit charities of claim 3 wherein said user interface specific to said first account or said second account includes a charity listing of a plurality of charities as beneficiaries of the required charitable donation.

4. The system for networking and fund raising to benefit charities of claim 1 wherein said user interface specific to said first account or said second account includes a charity list selector for choosing at least one charity as a beneficiary of the required charitable donation.

5. The system for networking and fund raising to benefit charities of claim 1 wherein said user interface specific to said first account or said second account includes an allocation control for setting an allocation percentage as a portion of the required charitable donation to be distributed to each of a plurality of charities.

6. The system for networking and fund raising to benefit charities of claim 1 wherein said bridge control includes an availability setting to designate the user as being available for the private meeting.

7. The system for networking and fund raising to benefit charities of claim 1 wherein said bridge control includes a schedule setting for allowing the user to designate at least one date and time that the user is available for the private meeting.

8. The system for networking and fund raising to benefit charities of claim 1 wherein said first user is an executive meeting a predetermined criteria.

9. The system for networking and fund raising to benefit charities of claim 1 further including a rating control; and
wherein the system records a rating from each of said first user and said second user who participate in a private meeting regarding another one of the participants of the private meeting using said rating control.

10. The system for networking and fund raising to benefit charities of claim 1 further including reward points being awarded to the users by the system for participation in a private meeting; and
wherein said reward points are redeemable by said users in exchange for a prize or as a donation to a charity.

11. The system for networking and fund raising to benefit charities of claim 1 further including an event being created by one of said users who is designated as a host of the event.

12. A system for organizing private meetings between individuals for professional networking and fund raising to benefit charities, the system comprising a server having a non-transitory computer readable storage medium having stored thereon instructions which, when executed by a processor of the server, causes the processor to perform the steps of:
receiving via a communications network a request from a first user to create a first account;
receiving via the communications network a request from a second user to create a second account;
receiving a selection from one of said first user or said second user to participate in a private meeting with another user who is designated as being available for a private meeting; and
prompting for the one of said first user or said second user requesting the private meeting to pay a required charitable donation setup by the other of the first user or the second user upon occurrence of the private meeting.

13. A computer implemented method for networking and fund raising to benefit charities comprising the steps of:
receiving by a server via a communications network a request from a first user to create a profile;
providing by a user device or the server, profile input fields for profile information about the first user;
receiving by the server via the communications network a request from a second user to create a profile;
providing by a user device or the server profile input fields for profile information about the second user;
selecting by a user a bridge invitation control to participate in a private meeting with another user who is designated as being available for private meetings;
prompting by a user device or the server for the user requesting the private meeting to pay a required charitable donation in order to participate in the private meeting.

14. The computer implemented method for networking and fund raising to benefit charities of claim 13 further including the step of presenting by a user device or the server the user requesting the private meeting with information regarding one or more charities as being recipients of at least a portion of the required charitable donation.

15. The computer implemented method for networking and fund raising to benefit charities of claim 13 further including the steps of:
designating, by the user hosting the private meeting, a plurality of time slots for a private meeting; and
selecting, by the user requesting the private meeting, one of the plurality of time slots for the private meeting.

16. The computer implemented method for networking and fund raising to benefit charities of claim 13 further including the steps of:
presenting by a user device or the server a user with a list of other users to whom the user can request to connect;
requesting a connection by a user who is designated as a connection requester another user who is designated as a connection requestee;
notifying the connection requestee by the server of the requested connection;
presenting the connection requestee by a user device or the server a list of options regarding the connection request including an option for accepting the connection and an option for rejecting the connection;
designating by a user device or the server the requester user and the requestee user as being connected in response to the requestee user accepting the connection request.

17. The computer implemented method for networking and fund raising to benefit charities of claim 16 further including the step of providing by the server a communications path between users who are designated as being connected with one another and which is not available between users who are not connected.

18. The computer implemented method for networking and fund raising to benefit charities of claim 13 further including the steps of:
providing by a user device or the server information regarding events;
providing by a user device or the server an event interface for a user to create and configure an event;
setting by a user of the system operating parameters for the event using controls on the event interface;
entering by a user of the system information regarding the event using controls on the event interface;
designating by a user device or the server the user creating the event as a host of the event;
selecting by the user creating the event other users of the system as hosts of the event;
providing by a user device or the server an auction for soliciting bids on private meetings in support of one or more charities; and
providing by a user device or the server a bidding period of time during which bids are collected for the private meetings available for bid.
